(19) United States
(12) Patent Application Publication
(10) Pub. No.: US 2016/0289478 A1
(43) Pub. Date: Oct. 6, 2016

(54) Dispersions Of Silver Nanoparticles

(71) Applicant: GENES'INK SA, Cedex (FR)

(72) Inventors: Louis Dominique Kauffmann, La Crau (FR); Nicolas Delpont, Venelles (FR); Virginie El Qacemi, Roquevaire (FR); Gregoire Staelens, Aix en Provence (FR)

(21) Appl. No.: 15/037,306

(22) PCT Filed: Nov. 24, 2014
(86) PCT No.: PCT/EP2014/075416

§ 371 Date: May 17, 2016

(30) Foreign Application Priority Data
Nov. 27, 2013 (FR) 1302744

(51) Int. Cl. C09D 11/52; B01F 17/00; C09D 11/36; C09D 11/38; C09D 11/037; C09D 11/033

(52) U.S. Cl. CPC C09D 11/52; C09D 11/037; C09D 11/033; C09D 11/36; C09D 11/38; B01F 17/0042

(57) ABSTRACT

The present invention relates to formulations of dispersions of silver nanoparticles and of inks based on said dispersions. In particular, the present invention relates to dispersions that are stable and have a high concentration of silver nanoparticles.

The present invention relates to formulations of nanoparticle-based dispersions and of inks based on said dispersions. In particular, the present invention relates to dispersions that are stable and have a high concentration of silver nanoparticles.

More particularly, the present invention relates to the field of inks based on conductive nanoparticles suitable for numerous printing methods. As nonlimiting examples, the following printing methods are mentioned: inkjet, spray, screen printing, gravure printing, flexography, doctor blade, spin coating, and slot die coating.

The inks based on conductive nanoparticles according to the present invention can be printed on any types of support. As examples, the following supports are mentioned: polymers and derivatives of polymers, composite materials, organic materials, inorganic materials.

The inks based on conductive nanoparticles according to the present invention have numerous advantages among which we will mention as nonlimiting examples:
a stability over time that is superior to the current inks;
versatility with regard to their field of application;
nontoxicity of the solvents and of the nanoparticles;
preservation of the intrinsic properties of the nanoparticles; and, in particular,
preservation of electronic properties, and
improved conductivity for annealing temperatures generally less than 200° C. and more particularly for annealing temperatures less than or equal to 150° C. This improved conductivity is generally demonstrated by measurement of the resistance per square of the material.

The present invention also relates to an improved method for preparing said dispersions and inks; finally, the present invention also relates to the use of said inks in the fields of printed electronics (for example, RFID (radio frequency identification) supports), photovoltaics, OLED (organic light emitting diode), sensors (for example, gas sensors), touch screens, biosensors, and contactless technologies.

With a view to the literature of recent years, much attention has been paid to conductive colloidal nanocrystals owing to their new optoelectronic, photovoltaic and catalytic properties. This makes them particularly advantageous for future applications in the field of nanoelectronics, solar cells, sensors, and in the biomedical field.

The development of conductive nanoparticles makes it possible to use new implementations and to foresee a multitude of new applications. The nanoparticles have a very high surface/volume ratio and the substitution of their surface with surfactants results in the change of certain properties, notably optical properties, and the possibility of dispersing them.

Their small dimensions can in some cases lead to quantum confinement effects. The nanoparticles are compounds at least one dimension of which is less than 100 nm. They can have different shapes: beads (from 1 to 100 nm), rods (L<200 to 300 nm), threads (several hundred nanometers and even several microns), disks, stars, pyramids, tetrapods, cubes or crystals when they do not have a predefined form.

Several methods have been elaborated for synthesizing conductive nanoparticles. Among those, one can mention in a nonexhaustive manner:

the physical processes:
chemical vapor deposition (CVD), when the substrate is exposed to volatilized chemical precursors which react or decompose on its surface. This process generally leads to the formation of nanoparticles whose morphology depends on the conditions used;
thermal evaporation;
molecular beam epitaxy, when the atoms that will constitute the nanoparticles are bombarded at high speed on the substrate (to which they will become attached), in the form of a gaseous flow;

the chemical or physicochemical processes:
microemulsion;
laser pulse in solution, when a solution containing a precursor is irradiated with a laser beam. The nanoparticles form in the solution along the light beam;
synthesis by irradiation with microwaves;
surfactant-assisted oriented synthesis;
synthesis under ultrasound;
electrochemical synthesis;
organometallic synthesis;
synthesis in an alcohol-based medium;
sol-gel chemistry;
redox synthesis.

The physical syntheses consume more raw materials with significant losses. In general, they require a large amount of time and high temperatures, and consequently they are not attractive candidates for the switch to industrial scale production. This makes them unsuitable for certain substrates, for example, flexible substrates. In addition, the syntheses are carried out directly on the substrate in frames with reduced dimensions. These production methods turn out to be relatively rigid and they do not allow production on substrates having large dimensions.

As to chemical syntheses, they have numerous advantages. The first is that the work is carried out in solution; the conductive nanoparticles thus obtained are already dispersed in a solvent, which facilitates their storage and use. In most cases, the nanoparticles are not attached to a substrate, which leads to greater freedom in their use. These methods also allow a better control of the raw materials utilized and they limit the losses. A good adjustment of the synthesis parameters leads to a good control of the synthesis and of the growth kinetics of the conductive nanoparticles. This makes it possible to guarantee a good reproducibility between batches as well as a good control of the final morphology of the nanoparticles. The difficult part is to obtain solutions that are colloidally stable over time without aggregation of the nanoparticles or precipitation. The customization of the surface of the nanoparticles makes it possible to effectively fight this phenomenon, by selecting stabilizing entities, such as ligands, for this purpose. These ligands prevent risks of aggregation and of sedimentation. They offer a second advantage by also impacting the properties of the ink formulated on the basis of these conductive nanoparticles. Thus, it is possible to adjust the nature of the ligands depending on the intended application. In the context of biomedical application, it is thus preferable to use ligands such as peptides that increase the biocompatibility of the nanoparticles in the biological medium. In the case of the printed electronics sector, this opens the way to the use of substrates of very different sizes and different types. Finally, these synthesis methods make it possible to produce in quantity stable solutions of nanoparticles within a relatively short time. All these points underline the assets and the flexibility of the chemical synthesis paths in terms of envisaging industrial scale production of nanoparticles.

The aim of the present invention is to overcome one or more disadvantages of the prior art by providing a stable and highly concentrated dispersion of silver nanoparticles as well as an ink including said dispersion.

According to an embodiment of the present invention, this aim is achieved by means of a dispersion whose composition includes at least:

a. a compound “a” consisting of silver nanoparticles,

b. a compound “b” consisting of a cyclooctane solvent and/or a solvent of the fatty acid methyl ester type and/or a terpene solvent selected from the hydrocarbons and their aldehyde, ketone and/or terpenic acid derivatives, and/or a mixture of two or more of said solvents,

c. a compound “c” consisting of a dispersing agent, and

d. a compound “d” consisting of a different dispersing agent different from the compound “c” used.

The applicant unexpectedly discovered that the specific combination of the components of the dispersion according to the present invention made it possible to obtain dispersions of highly concentrated silver nanoparticles with improved stability.

The present invention therefore also relates to an ink the composition of which includes at least

1. a dispersion according to the present invention (with compounds “a,” “b,” “c” and “d”),

2. a compound “e” consisting of a solvent different from the compound “b” used, and

3. an optional compound “f” consisting of a rheology modifying agent.

The viscosity of the ink according to the present invention is preferably between 1 and 10,000 mPa·s, more preferably between 1 and 1000 mPa·s, for example, between 2 and 20 mPa·s.

The applicant has discovered that the combination of the dispersion according to the present invention with compound “e” and optional compound “f” made it possible to obtain an ink with improved properties, in particular a better stability.

This makes this ink particularly attractive for uses in the field of printed electronics (for example, RFID (radio frequency identification) supports), photovoltaics, OLEDs (organic light emitting diode), sensors (for example, gas sensors), touch screens, biosensors, and contactless technologies.

Compound “a” according to the invention thus consists of silver nanoparticles.

According to an embodiment variant of the present invention, the aims of the present invention are achieved particularly satisfactorily when compound “a” consists of silver nanoparticles whose dimensions are between 1 and 50 nm, preferably between 2 and 20 nm. The size of the nanoparticles is defined as being the mean diameter of the particles that contain silver, excluding the stabilizers, as determined by transmission electron microscopy, for example.

According to an embodiment variant of the present invention, the silver nanoparticles are of spheroidal and/or spherical shape. For the present invention and the claims that follow, the term “of spheroidal shape” means that the shape resembles that of a sphere but is not perfectly round (“quasi spherical”), for example, an ellipsoid shape. The shape of the nanoparticles is generally identified by means of photographs taken with a microscope. Thus, according to this embodiment variant of the present invention, the nanoparticles have diameters between 1 and 50 nm, preferably between 2 and 20 nm.

According to a particular embodiment of the present invention, the silver nanoparticles are synthesized beforehand by chemical synthesis. Any chemical synthesis can be used preferentially in the context of the present invention. In a preferred embodiment according to the present invention, the silver nanoparticles are obtained by a chemical synthesis that uses an organic or inorganic silver salt as silver precursor. The following are mentioned as non-limiting examples: silver acetate, silver nitrate, silver carbonate, silver phosphate, silver trifluorate, silver chloride, silver perchlorate, alone or in a mixture. According to a preferred variant of the present invention, the precursor is silver acetate.

According to a preferred embodiment of the present invention, the silver nanoparticles are thus synthesized by chemical synthesis, by reduction of the silver precursor by means of a reducing agent in the presence of the dispersing agent referred to as “compound “c” of the present invention; this reduction can be carried out in the absence or in the presence of a solvent (hereafter also referred to as the “synthesis solvent”). When the synthesis is carried out in the absence of solvent, the dispersing agent generally acts both as dispersing agent and as solvent of the silver precursor; a particular example of synthesis of nanoparticles in a medium without solvent and of preparation of the dispersion according to the present invention is described by way of example below.

Preparation of the dispersion of the nanoparticles in solvent “b:” in a reactor containing silver acetate, the synthesis dispersing agent (compound “c;” for example, dodecylamine) is added in excess and the mixture is stirred for less than 30 minutes at 65° C. The hydrazine reducing agent is then added rapidly to the mixture and the entire mixture is stirred for approximately 60 minutes. The mixture is treated by the addition of methanol (or any other appropriate solvent, for example, another monohydric alcohol having 2 to 3 carbon atoms, for example, ethanol), and the supernatant is eliminated in the course of several successive washes (the silver nanoparticles thus formed remain therefore in the state of a dispersion and in contact with liquid). The solvent cyclooctane (compound “b”) is added and the residual methanol is evaporated. Compound “d” (a dispersing agent different from the compound “b” used; for example, an octylamine) is then added and the mixture is stirred for 15 minutes at ambient temperature. The dispersions of silver nanoparticles thus obtained are used directly for the formulation of the conductive inks.

In general, when the synthesis is carried out in the presence of solvent, the silver precursor is dissolved in said synthesis solvent; this synthesis solvent is preferably different from compound “b” (hereafter also referred to as the “dispersion solvent”). The synthesis solvent is preferably an organic solvent selected from the following list of hydrocarbons:
the alkanes having 5 to 20 carbon atoms of which the following are mentioned by way of example: pentane (C5H12), hexane (C6H14), heptane (C7H16), octane (C8H18), nonane (C9H20), decane (C10H22), undecane (C11H24), dodecane (C12H26), tridecane (C13H28), tetradecane (C14H30), pentadecane (C15H32), cetane (C16H34), heptadecane (C17H36), octadecane (C18H38), nonadecane (C19H40), eicosane (C20H42), cyclopentane (C5H10), cyclohexane (C6H12), methylcyclohexane (C7H14), cycloheptane (C7H14), cyclooctane (C8H16) (preferably when it is not used as compound “b”), cyclononane (C9H18), cyclodecane (C10H20);
the aromatic hydrocarbons having from 7 to 18 carbon atoms, of which the following are mentioned by way of example: toluene, xylene, ethyl benzene, ethyl toluene; and
their mixtures.

According to an essential embodiment of the present invention, at least one dispersing agent (compound “c”) is also present in addition to the silver precursor—and in addition to the synthesis solvent (when the latter is used).

This dispersing agent, which we will call the synthesis dispersing agent corresponding to the above-mentioned compound “c” is preferably selected from the list of the dispersing agents described below in the description.

According to a preferred embodiment of the present invention, the silver nanoparticles are thus synthesized by chemical synthesis, by reduction of the silver precursor by means of a reducing agent in the presence of the synthesis dispersing agent (compound “c”), all of this taking place preferably in the synthesis solvent. This synthesis is preferably carried out under non-restrictive pressure and temperature conditions as defined below in the present description.

The reducing agent can be selected from a wide range of compounds allowing the reduction of the silver precursor. By way of example, the following compounds are mentioned: hydrogen; the hydrides, among which we mention as examples, NaBH4, LiBH4, KBH4, and tetrabutylammonium borohydride; the hydrazines, among which we mention as examples, hydrazine (H2N-NH2), substituted hydrazine (methylhydrazine, phenylhydrazine, dimethylhydrazine, diphenylhydrazine, etc.), hydrazine salt (substituted), etc.; the amines, among which we mention as examples, trimethylamine, triethylamine, etc.; and their mixtures.

In general, after the reduction step, the nanoparticles are then subjected to a washing/purification step which makes it possible to eliminate anything that is not chemically or physically bound to the nanoparticles.

According to a particular embodiment of the present invention, a liquid phase is always present, during the step of reduction of the silver precursor and also during all the steps (for example, the above-mentioned washing and purification steps) that precede the addition of compound “b.” In other words, a preferred characteristic according to the invention is that the silver nanoparticles are never isolated and dried; they remain thus preferably always in contact with a liquid phase (for example, a solvent) in which they are dispersed. As demonstrated earlier on in the description, this characteristic makes it possible to considerably improve certain properties (monodispersion, homogeneity, stability, and annealing at lower temperature) of the silver nanoparticles. This approach makes it possible to eliminate the step of isolation of the nanoparticles, which has a positive impact in terms of the costs of production and for personal hygiene and safety.

Compound “b” according to the present invention thus consists of a cyclooctane solvent and/or a solvent of the fatty acid methyl ester type and/or a terpene solvent selected from the hydrocarbons and their aldehyde, ketone and/or terpenic acid derivatives, and/or a mixture of two or more of said solvents.

The solvent of the fatty acid methyl ester type is preferably one with a short hydrocarbon chain; for example, a chain including between 4 and 8 carbon atoms. The following are mentioned as examples: methyl butanoate, methyl hexanoate, and/or methyl octanoate.

The terpene solvent is preferably of the monoterpene type. Hydrocarbons as well as their terpene derivatives (aldehydes, ketones and acids), preferably terpene hydrocarbons are mentioned as examples. As examples the following are mentioned: limonene, menthone, camphor, myrcene and/or betapinene.

The compounds “c” (synthesis dispersing agent) and “d” (dispersing agent) according to the present invention thus consists of dispersing agents characterized in that the dispersing agent “d” is different from the agent “c” used. This difference manifests itself in a different chemistry: by way of example, we mention a different carbon chain length (for example, a difference of at least two carbon atoms in the chain), and/or one compound having a linear carbon chain and the other not, and/or one compound having a cyclic carbon chain and the other not, and/or one compound having an aromatic carbon chain and the other not. According to a preferred embodiment of the present invention, compound “c” has a molecular weight and/or a carbon chain length that is/are at least 20% greater than that of compound “d,” for example, at least 40% greater.

These dispersing agents can advantageously be selected from the families of organic dispersing agents that include at least one carbon atom. These organic dispersing agents can also include one or more nonmetallic heteroatoms, such as a halogenated compound, nitrogen, oxygen, sulfur, silicon.

The following are mentioned by way of example: the thiols and their derivatives, the amines and their derivatives (for example, the amino alcohols and the amino alcohol ethers), the carboxylic acids and their carboxylate derivatives, the polyethylene glycols, and/or their mixtures.

In a preferred embodiment of the present invention, the organic dispersing agents “c” and “d” will be selected from the group consisting of amines, such as, for example, propylamine, butylamine, pentylamine, hexylamine, heptylamine, octylamine, nonylamine, decylamine, undecylamine, dodecylamine, tridecylamine, tetradecylamine, hexadecylamine, diaminopentane, diaminohexane, diaminoheptane, diaminooctane, diaminononane, diaminodecane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine, or their mixtures.

According to a preferred embodiment of the present inventions, compounds “b” and “d” are added to the already synthesized silver nanoparticles in the presence of compound “c.”

This addition generally takes place after the steps of washing/purification of the nanoparticles as described in the present description.

A particular example of synthesis of nanoparticles and of preparation of the dispersion according to the present invention is described below by way of example:

Preparation of the dispersion of the nanoparticles in solvent “b.”

In a reactor containing silver acetate in toluene, the synthesis dispersing agent (compound “c;” for example, dodecylamine) is added and the mixture is stirred for at least 30 minutes at 65° C. The hydrazine reducing agent is then added rapidly to the mixture and the entire mixture is left to stand under stirring for approximately 60 minutes. The mixture is treated by the addition of methanol (or any other appropriate solvent, for example, another monohydric alcohol having from 2 to 3 carbon atoms, for example, ethanol) and the supernatant is eliminated in three successive washes (the silver nanoparticles thus formed therefore remain in the state of a dispersion and in contact with liquid, in this case in contact with methanol). The cyclooctane solvent (compound “b”) is added and the residual methanol is evaporated. Compound “d” (a dispersing agent different from the compose “b” being used—for example, an octylamine) is then added and the mixture is stirred for 15 minutes at ambient temperature. The dispersions of silver nanoparticles thus obtained are used directly for the formulation of the conductive inks.

According to a preferred embodiment variant of the present invention, the nanoparticles that are used are characterized by D50 values (which can be measured, for example, by means of the method described below), which are preferably between 2 and 12 nm.

For the nanoparticles synthesized in the presence of solvent, the preferred D50 range will be between 2 and 8 nm; for the nanoparticles synthesized in the absence of solvent, the preferred D50 range will be between 5 and 12 nm.

The dispersion thus obtained can be used directly or it can be diluted before being incorporated, for example, in an ink in order to obtain the desired properties. However, and this represents a considerable advantage of the dispersions according to the present invention, said dispersions are characterized by a superior stability (before dilution) as demonstrated in the examples.

According to an embodiment of the present invention, the dispersion of silver nanoparticles comprises:
a compound “a” at a content greater than 30% by weight, preferably greater than 35% by weight, for example, greater than 40% by weight,
a compound “b” at a content between 20 and 65% by weight, preferably between 40 and 600/% by weight,
a compound “c” at a content between 3 and 15% by weight, preferably between 3 and 10% by weight, and
a compound “d” at a content between 0.1 and 15% by weight, preferably between 0.4 and 5% by weight.

According to an embodiment of the present invention, the dispersion of silver nanoparticles can also incorporate in its composition additional compounds among which we mention as examples solvents (for example, ethers, alcohols, esters) and/or additives (for example, polymers), the purpose of which can be, for example, the improvement of the dispersion of the nanoparticles. However, compounds “a,” “b,” “c,” and “d” (in the ranges of proportions indicated above) preferably will constitute at least 55% by weight of the final dispersion, preferably at least 750/% by weight, for example, at least 90% by weight, at least 95% by weight, at least 99% by weight, or even 100% by weight of the final dispersion.

According to an embodiment of the present invention, the dispersion of silver nanoparticles does not incorporate water in its composition. However, since the components of the dispersion can tolerate traces of water depending on their degree of purity, it is natural that the total of these corresponding water traces will be acceptable in the dispersions of silver nanoparticles according to the present invention. Thus, the water content in the final dispersion depends generally essentially on the water content of the solvents used for its preparation; monohydric alcohol (the methanol for washing the dispersion in our embodiment example above) will have in this regard the strongest impact—in comparison to the other solvents used in the preparation of the dispersion—on the final water content of the dispersion. According to a particular embodiment of the present invention, the dispersions of silver particles include water concentrations less than 2% by weight, preferably less than 1% by weight, for example, less than 0.5% by weight, or even less than 0.2% by weight.

According to a preferred embodiment of the present invention, with the exception of traces of water that may be present in the formulation/preparation compounds of the dispersion, no water is added during the formulation of dispersions of silver nanoparticles.

Compound “e” present in the ink according to the present invention thus consists of a solvent different from compound “b” used (cyclooctane and/or fatty acid methyl ester and/or terpene solvent).

This solvent compound “e” is preferably characterized by a higher polarity than the dispersion solvent used and/or a boiling point less than 260° C. It belongs preferably to the category of the alcohols and/or the alcohol derivatives (for example, glycol ethers). The following are mentioned as examples: monohydric alcohols (for example, isopropanol, butanol, pentanol, hexanol, . . . ) and/or the glycols (for example, ethylene glycol, propylene glycol, diethylene glycol . . . ), and/or the glycol ethers (for example, the glycol mono- or diethers, among which we mention as examples ethylene glycol propyl ether, ethylene glycol butyl ether, ethylene glycol phenyl ether, diethylene glycol methyl ether, diethylene glycol ethyl ether, diethylene glycol propyl ether, diethylene glycol butyl ether, propylene glycol methyl ether, propylene glycol butyl ether, propylene glycol propyl ether, ethylene glycol dimethyl ether, ethylene glycol diethyl ether, ethylene glycol dibutyl ether, glymes, diethylene glycol diethyl ether, dibutylene glycol diethyl ether, diglymes, ethyl diglyme, butyl diglyme), and/or the glycol ether acetates (for example, 2-butoxyethyl acetate, diethylene glycol monoethyl ether acetate, diethylene glycol butyl ether acetate, propylene glycol methyl ether acetate) and/or a mixture of two or more of said above-mentioned solvents.

The optional compound “f” according to the present invention thus consists of a rheology modifying agent. The following are mentioned as examples: the alkylcelluloses, preferably ethylcellulose, the nitrocellulose, alkyd and acrylic resins, and the modified ureas, preferably the polyureas, and/or their mixtures.

According to a particular embodiment of the present invention, the ink compositions can also include an additional solvent which we will call solvent “X” and which can be selected advantageously from one or more of the nanoparticle synthesis solvents and/or the above-mentioned dispersion solvents “b” and/or a mixture of two or more of said solvents. The use of this (these) additional solvent(s) is particularly advantageous for the use of compound “f” when the latter is used in the composition of the ink according to the invention. According to a particular embodiment according to the present invention, the solvent “X” is identical to the solvent “b” used.

A particular example of the preparation of the ink according to the present invention is described by way of example below: a rheology modifying agent of the polyurea type (compound “f”) is added under stirring and at ambient temperature in a reactor containing a mixture of solvent “e” and “X” (butanol and cyclooctane). The solution of silver nanoparticles in dispersion (mixture of compounds “a,” “b,” “c,” and “d”) is added and the whole is stirred for 15 min at ambient temperature.

According to a particular embodiment of the present invention, the inks formulated according to the present invention have a content less than 60% by weight of nanoparticles (compound “a”), preferably between 5 and 45%, and more particularly between 10 and 40% by weight.

According to an embodiment of the present invention, the silver ink includes
a dispersion according to the present invention (with compounds “a,” “b,” “c” and “d”), at a content less than or equal to 60% by weight, and preferably more than 5% by weight, preferably more than 10% by weight, for example, more than 20% by weight and even more than 40% by weight,
compound “e” at a content between 1 and 40% by weight, preferably between 15 and 30% by weight,
optional compound “f” at a content less than 20% by weight, preferably between 0.1 and 2% by weight, and
an optional compound “X” at a content less than 60% by weight, preferably less than 40% by weight, and preferably greater than 5% by weight, for example, greater than 15% by weight.

According to an embodiment of the present invention, the ink can also incorporate in its composition other compounds among which we mention as examples additives (for example, an additive of the silane family), the purpose of which can be, for example, to improve the resistance to different types of mechanical stress, for example, the adhesion to numerous substrates; the following substrates can be mentioned by way of example: polyimide, polycarbonate, polyethertetphthalate (PET), polyethylene naphthalate (PEN), polyaryl ether ketone, polyester, thermostabilized polyester, glass, ITO glass, AZO glass, SiN glass.

However, compounds “a,” “b,” “c,” “d,” “e,” “f” and “X” (in the ranges of proportions indicated above) preferably will constitute at least 5% by weight of the final ink, preferably at least 75 wt %, for example, at least 900% by weight, at least 95% by weight, at least 99% by weight, or even 1000% by weight of the final ink.

According to an embodiment of the present invention, the ink does not incorporate water in its composition. However, since the components of the ink can tolerate traces of water depending on their degree of purity, the total of these corresponding traces of water will naturally be acceptable in the inks according to the present invention. Thus, the water content in the final ink depends in general essentially on the water content of the solvents used for its preparation; monohydric alcohol (the methanol for washing the dispersion in our embodiment example above) in this regard will have the greatest impact—in comparison with the other solvents used in the preparation of the ink—on the final water content of the ink. According to a particular embodiment of the present invention, the inks include water concentrations of less than 2% by weight, preferably less than 1% by weight, for example, less than 0.5% by weight, or even less than 0.2% by weight.

According to a preferred embodiment of the present invention, with the exception of traces of water that are possibly present in the compounds for formulation/preparation of the ink, no water is added during the formulation of the inks.

According to an embodiment variant of the present invention, the preparation of the dispersion of nanoparticles according to the present invention is characterized by the following steps:

a. synthesis of the silver nanoparticles in the presence of the dispersing agent (compound “c”) by reduction by means of a reducing agent of a silver precursor,

b. washing/purification of the nanoparticles obtained in step “a,”

c. additions of compound “b” and of compound “d.”

According to a preferred embodiment variant of the present invention, a liquid phase is always present during all these preparation steps. In other words, a preferred characteristic according to the present invention thus consists in that the silver nanoparticles are never isolated and dried; consequently, they remain preferably always in contact with a liquid phase (for example, a solvent) in which they are dispersed.

According to a preferred embodiment variant of the present invention, during step “a,” the addition of the reducing agent is carried out in any appropriate container (for example, a reactor) with the characteristic that it occurs below level, for example, using a plunger introduced directly into the reaction medium.

An additional advantage of the dispersion according to the present invention lies in the fact that its preparation can be carried out under non-restrictive pressure and/or temperature conditions, for example, under pressure and/or temperature conditions close to standard or ambient conditions. It is preferable to remain within less than least 40% of the standard or ambient conditions of pressure and, as far as temperature is concerned, the latter is generally less than 80° C., preferably less than 70° C. For example, the applicant has noted that it is preferable to maintain the pressure conditions during the preparation of the dispersion at values varying by at most 30%, preferably 15% around the standard or ambient pressure conditions, preferably close to atmospheric pressure. Monitoring of these pressure and/or temperature conditions can advantageously be included in the device for preparing the dispersion so as to satisfy these conditions.

This advantage connected with a preparation of the dispersion under non-restrictive conditions is quite clearly also reflected in a facilitated use of said dispersions.

According to an embodiment variant of the present invention, the preparation of the nanoparticle-based ink according to the present invention is characterized by the following consecutive steps:

a. introduction of compound “e” into a container, and

b. addition of the dispersion according to the present invention to said container.

The ink thus obtained can be used directly or it can be diluted in order to obtain the desired properties.

According to a particular embodiment of the present invention, when a rheology modifying agent (compound “f”) is used in the composition of the ink, said ink formulations include preferably an additional solvent (solvent “X”). In this particular embodiment, the preparation of the nanoparticle-based ink according to the present invention is characterized by the following consecutive steps:

a. use of the compound “f” in a mixture of compounds “e” and “X,” and

b. addition of the dispersion according to the present invention.

An additional advantage of the ink according to the present invention consists of the fact that its preparation can be carried out under non-restrictive pressure and/or temperature conditions, for example, under pressure and/or temperature conditions close to or identical to the standard or ambient conditions. It is preferably to remain within less than 40% of the standard or ambient pressure and/or temperature conditions. For example, the Applicant has noted that it is preferable to maintain the pressure and/or temperature conditions during the preparation of the ink at values varying by at most 30%, preferably 15% around the standard or ambient conditions. Monitoring of these pressure and/or temperature conditions can thus be included advantageously in the device for preparing the ink so as to satisfy these conditions. This advantage connected with a preparation of the ink under non-restrictive conditions is quite clearly also reflected in a facilitated use of said inks.

According to an embodiment of the present invention, the ink can be used advantageously in any printing method, in particular inkjet, spray, screen printing, gravure printing, flexography, doctor blade, spin coating, and slot die coating.

It is thus evident to the person skilled in the art that the present invention allows embodiments in numerous other specific forms without thereby diverging from the field of application of the invention as claimed. Consequently, the present embodiments must be considered examples that can, however, be modified within the field as defined by the scope of the attached claims.

The present invention and its advantages will now be illustrated by means of the formulations listed in the table below. The synthesis of the dispersions (in the presence of synthesis solvent—toluene) and the ink formulations were prepared in accordance with the preferred embodiments described above in the description. The chemical compounds used are indicated in the second column of the table.

The resistance per square of the ink as mentioned in the present invention can be measured by any appropriate method. As an example corresponding to the measurements listed in the table, it can be measured advantageously according to the following method:

An ink deposited by spin coater on a substrate (600 rpm/3 min—for example, glass) is subjected to annealing using a heating plate or a furnace. An analysis of the resistance per square is carried out under the following conditions:

Reference of the apparatus: S302 Resistivity Stand

4-Point head reference: SP4-40045TFY

Power supply reference: Agilent US001A

Multimeter reference: Agilent U3400

Measurement temperature: ambient temperature

Voltage/resistance conversion coefficient: 4.5324

Example 1 (formulation 1 of the table below): 50 mohm/sq for a thickness of 1.3 m on polyimide or polyester—150° C./30 min.

According to an embodiment variant of the present invention, the Applicant discovered that the values of resistance per square (measured as described above) of the inks obtained according to the present invention were preferably less than 100 mohm/sq for thicknesses greater than or equal to 1 μm (annealing temperature of 150° C.). This particular property of resistance per square confers to the inks of the present invention an improved conductivity for lower annealing temperatures less than 200° C. and more particularly for annealing temperatures less than or equal to 150° C. (as demonstrated in the example and the measurement).

The content of silver nanoparticles as mentioned in the present invention can be measured using any appropriate measurement. As an example corresponding to the measurements indicated in the table, it can be measured advantageously according to the following method:

Thermogravimetric analysis

Apparatus: TGA Q50 from TA Instrument

Crucible: Alumina

Method: ramp

Measurement range: from ambient temperature to 600° C.

Temperature rise: 10° C./min

The distribution of the sizes of the silver nanoparticles (in the D50 dispersion) as mentioned in the present invention can be measured by any appropriate method. As an example, it can be measured advantageously according to the following method: use of a Nanosizer S apparatus from Malvern with the following characteristics:

DLS (dynamic light scattering) measurement method:
Type of tank: optical glass
Material: Ag
Refractive index of the nanoparticles: 0.54
Absorption: 0.001
Dispersant: Cyclooctane
Temperature: 20° C.
Viscosity: 2.133
Dispersant refractive index: 1.458
General Options: Mark-Houwink parameters
Analysis Model: General purpose
Equilibration: 120 s
Measurement number: 4

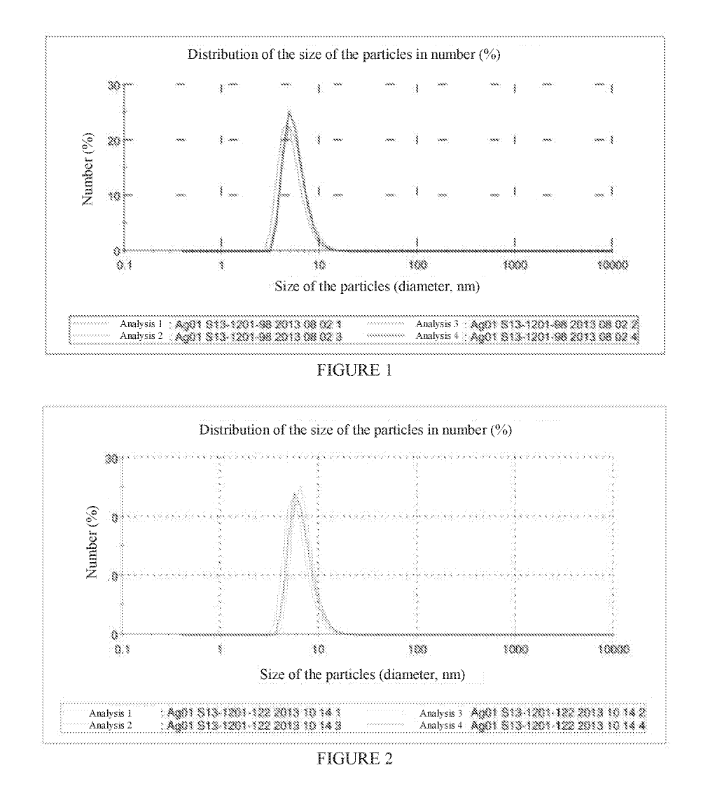

FIGS. 1 and 2 are representative of a general example of a DLS (dynamic light scattering) spectrum obtained during the synthesis of nanoparticles according to the present invention with synthesis solvent (FIG. 1) and without synthesis solvent (FIG. 2), respectively. They show the granulometric spectra in terms of number of the size (in nm) of the silver nanoparticles.

FIG. 1—D50: 5.6 nm

FIG. 2—D50: 8.0 nm

D₅₀ is the diameter for which 50%, in number, of the silver nanoparticles are smaller. This value is considered to be representative of the mean size of the grains.

The viscosity of the ink as mentioned in the present invention can be measured according to any appropriate method. As an example, it can be measured advantageously according to the following method:

Apparatus: Rheometer AR-G2 from TA Instrument

Conditioning time: 1 minute for formulations 1, 2 and 3, and 30 minutes for formulation 4

Test type: Continuous ramp

Ramp: Shearing rate (l/s)

From: 0.001 to 40 (1/s)

Duration: 5 minutes

Mode: linear

Measurement: every 10 seconds

Temperature: 20° C.

Curve reprocessing method: Newtonian

Reprocessed area: the entire curve

TABLE

| | Component | Name | Dispersion | F1 | F2 | F3 | F4 |
|---|---|---|---|---|---|---|---|
| Dispersion | “a” | Ag | 45.05 | 20.00 | 20.00 | 20.00 | 20.00 |
| | “b” | cyclooctane | 49.84 | 22.13 | 22.13 | 22.13 | 22.13 |
| | “c” | dodecylamine | 4.50 | 2.00 | 2.00 | 2.00 | 2.00 |
| | “d” | octylamine | 0.61 | 0.27 | 0.27 | 0.27 | 0.27 |
| | “e” | 1-Butanol | | 20.00 | 20.00 | 20.00 | 20.00 |
| | “e′” | cyclooctane | | 35.40 | 30.40 | 35.60 | 34.60 |
| | “e″” | Diethylene glycol | | 0.00 | 5.00 | 0.00 | 0.00 |
| | | dibutyl ether | | | | | |
| | “f” | Polyurea- | | 0.20 | 0.20 | 0.00 | 1.00 |
| | | BYK410D | | | | | |
| | | % tot | 100 | 100.00 | 100.00 | 100.00 | 100.00 |
| | | R/square (mΩ/sq) | 200 | 50 | 180 | 190 | 60 |
| | | thickness (μm) | 0.3 | 1.3 | 0.3 | 0.3 | 1.1 |
| | | Viscosity (cP) | 4 | 10 | 10 | 4 | 220 |

1. Silver nanoparticle-based dispersion the composition of which comprising at least:
a. a compound “a” consisting of silver nanoparticles;
b. a compound “b” consisting of a cyclooctane solvent and/or a solvent of the fatty acid methyl ester type and/or a terpene solvent selected from the hydrocarbons and their aldehyde, ketone and/or terpenic acid derivatives, and/or a mixture of two or more of said solvents;
c. a compound “c” consisting of a dispersing agent; and
d. a compound “d” consisting of a dispersant agent different from the compound “c” used.

2. Dispersion according to claim 1, wherein the organic dispersing agents “c” and “d” are amines selected from the group consisting of propylamine, butylamine, pentylamine, hexylamine, heptylamine, octylamine, nonylamine, decylamine, undecylamine, dodecylamine, tridecylamine, tetradecylamine, hexadecylamine, diaminopentane, diaminohexane, diaminoheptane, diaminooctane, diaminononane, diaminodecane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine, and a mixture of two or more of these compounds.

3. Dispersion according to claim 1 further including:
compound “a” at a content selected from the group consisting of greater than 30% by weight, than 35% by weight, greater than 40% by weight;
compound “b” at a content selected from the group consisting of between 20 and 65% by weight, and between 40 and 60% by weight;
compound “c” at a content selected from the group consisting of between 3 and 15% by weight, and between 3 and 10% by weight; and
compound “d” at a content selected from the group consisting of between 0.1 and 15% by weight, and between 0.4 and 5% by weight.

4. Dispersion according to claim 1, wherein the silver nanoparticles are synthesized by a chemical route by reduction of a silver precursor in presence of a synthesis solvent and in that the synthesis solvent used is different from the compound “b” used.

5. Dispersion to according to claim 1, wherein compounds “a,” “b,” “c,” and “d” constitute by weight selected from the group consisting of at least 55% by weight of a final dispersion, at least 75% by weight, at least 90% by weight, at least 95% by weight, at least 99% by weight, and 100% by weight of the final dispersion.

6. Dispersion according to claim 1 further including a water content selected from the group consisting of less than 2% by weight, less than 1% by weight, less than 0.5% by weight, and less than 0.2% by weight.

7. Silver nanoparticle-based ink having a composition comprising at least:
a. a dispersion;
b. a compound “e” consisting of a solvent different from the compound “b” used and
c. an optional compound “f” consisting of a rheology modifying agent.

8. Ink according to claim 7, having a viscosity between 2 and 20 mPa·s.

9. Ink according to claim 7, wherein compound “e” is an alcohol selected from the group consisting of monohydric alcohols, glycols glycol, mono- or diethers the glycol ether acetates and a mixture of two or more of said alcohols.

10. Ink according to claim 7 further including compound “f” (rheology modifying agent) is present and selected from the group consisting of alkylcelluloses, ethylcellulose, the nitrocelluloses, alkyd and acrylic resins and the modified ureas, polyureas, and their mixtures.

11. Ink according to claim 7 further including an additional solvent, compound “X,” which is identical to compound “b.”

12. Ink according to claim 7 further including:
the dispersion having a content selected from the group consisting of less than or equal to 60% by weight, and greater than 5% by weight, greater than 10% by weight, and greater than 20% by weight;
compound “e” at a content selected from the group consisting of between 1 and 40% by weight, and between 15 and 30% by weight;
optional compound “f” at a content selected from the group consisting of less than 20% by weight, and between 0.1 and 2% by weight; and
an optional compound “X” at a content selected from the group consisting of less than 60% by weight, less than 40% by weight, greater than 5% by weight, and greater than 15% by weight.

13. Ink according to claim 7 wherein the compounds “a,” “b,” “c,” “d,” “e,” “f” and “X” constitute weight selected from the group consisting of at least 50% by weight of a final ink, at least 75% by weight, at least 90% by weight, at least 95% by weight, at least 99% by weight, an 100% by weight of the final ink.

14. Ink according to claim 7 having a water content selected from the group consisting of less than 2% by weight, less than 1% by weight, less than 0.5% by weight, less than 0.2% by weight.

15. Method for preparing the dispersion of nanoparticles according to claim 1, comprising of the following steps:
a. synthesis of silver nanoparticles in the presence of the dispersing agent (compound “c”) by reduction by means of at least one reducing agent of a silver precursor,
b. washing/purification of the nanoparticles obtained in step “a”;
c. additions of compound “b” and of compound “d”; and
wherein a liquid phase is always present in these preparation steps.

16. Method for preparing ink wherein the dispersion was prepared according to claim 15.

17. The ink according to claim 7, wherein the dispersion comprises:
a. a compound “a” consisting of silver nanoparticles;
b. a compound “b” consisting of a cyclooctane solvent and/or a solvent of the fatty acid methyl ester type and/or a terpene solvent selected from the hydrocarbons and their aldehyde, ketone and/or terpenic acid derivatives, and/or a mixture of two or more of said solvents;
c. a compound “c” consisting of a dispersing agent; and
d. a compound “d” consisting of a dispersant agent different from the compound “c” used.

18. The ink according to claim 7, wherein the dispersion includes the organic dispersing agents “c” and “d” selected from the group consisting of propylamine, butylamine, pentylamine, hexylamine, heptylamine, octylamine, nonylamine, decylamine, undecylamine, dodecylamine, tridecylamine, tetradecylamine, hexadecylamine, diaminopentane, diaminohexane, diaminoheptane, diaminooctane, diaminononane, diaminodecane, dipropylamine, dibutylamine, dipentylamine, dihexylamine, diheptylamine, dioctylamine, dinonylamine, didecylamine, methylpropylamine, ethylpropylamine, propylbutylamine, ethylbutylamine, ethylpentylamine, propylpentylamine, butylpentylamine, tributylamine, trihexylamine, and a mixture of two or more of these compounds.

19. The ink according to claim 7, wherein the dispersion further includes:
compound “a” at a content selected from the group consisting of; greater than 30% by weight, greater than 35% by weight, and greater than 40% by weight;
compound “b” at a content selected from the group consisting of between 20 and 65% by weight and between 40 and 60% by weight;
compound “c” at a content selected from the group consisting of between 3 and 15% by weight, and between 3 and 10% by weight; and
compound “d” at a content selected from the group consisting of between 0.1 and 15% by weight and between 0.4 and 5% by weight.

20. The ink according to claim 7, wherein the dispersion further includes the silver nanoparticles synthesized by a chemical route by reduction of a silver precursor in presence of a synthesis solvent and the synthesis solvent used is different from the compound “b” used.

21. The ink according to claim 7, wherein the dispersion further includes compounds “a,” “b,” “c,” and “d” constitute by weight selected from the group consisting of at least 55% by weight of the final dispersion, at least 75% by weight, at least 90% by weight, at least 95% by weight, at least 99% by weight, and 100% by weight of a final dispersion.

22. The ink according to claim 7, wherein the dispersion further includes a water content selected from the group consisting of less than 2% by weight, less than 1% by weight, less than 0.5% by weight, and less than 0.2% by weight.
